(19) United States
(12) Patent Application Publication
(10) Pub. No.: US 2018/0159425 A1
(43) Pub. Date: Jun. 7, 2018

(54) DC-DC CONVERTER

(71) Applicant: DONGAH ELECOMM CORPORATION

(72) Inventors: Soonsang HWANG, Yongin-si (KR); Taejin KO, Yongin-si (KR); Youngdo YOO, Busan (KR)

(73) Assignee: DONGAH ELECOMM CORPORATION, Yongin-si, Gyeonggi-do (KR)

(21) Appl. No.: 15/521,113

(22) PCT Filed: Jan. 12, 2017
(86) PCT No.: PCT/KR2017/000421

§ 371 Date: Apr. 21, 2017

(30) Foreign Application Priority Data
Dec. 5, 2016 (KR) 10-2016-0164537

(51) Int. Cl. H02M 1/40; H02M 3/28

(52) U.S. Cl. CPC H02M 1/40; H02M 3/28

(57) ABSTRACT

DC-DC converter according to an exemplary embodiment of the inventive concept includes: a first transformation unit including a first primary winding and a second primary winding and configured to convert a voltage applied to the first primary winding or the second primary winding and output the converted voltage to a first secondary winding; a second transformation unit including a third primary winding and a fourth primary winding and configured to convert a voltage applied to the third primary winding or the fourth primary winding and output the converted voltage to a second secondary winding, wherein the first primary winding and the third primary winding are connected to each other in series, and the second primary winding and the fourth primary winding are connected to each other in series.

### CROSS-REFERENCE TO RELATED APPLICATIONS

This application is a National Stage of International Application No. PCT/KR2017/000421, filed Jan. 12, 2017, and claims priority from Korean Patent Applications No. 10-2016-0164537 filed Dec. 5, 2016, the contents of which are incorporated herein by reference in their entireties.

### BACKGROUND

### 1. Field

The inventive concept relates to a DC-DC converter, and more particularly, to a DC-DC converter including a plurality of transformers.

### 2. Description of the Related Art

In recent communication systems, high-capacity rectifiers of several to several hundred kW or more are required. Typically, a high-capacity rectifier consists of a two-stage including an AC-DC converter and a DC-DC converter. The AC-DC converter included in the high-capacity rectifier outputs a high voltage of 600V or more, so that the DC-DC converter may cause transformer loss due to a high voltage conversion ratio.

Korean Patent No. 10-1464478 discloses a DC-DC converter for preventing the above problem. The DC-DC converter has 3-level inputs and inputs of two LLC resonant converters are connected to each other in series. A multi-input transformer divides and converts a high voltage, thereby reducing the transformer loss described above and loss due to characteristics of a passive device. In addition, the DC-DC converter uses the multi-input transformer to solve voltage and current imbalance between levels of input stages that can occur when using a plurality of transformers.

However, the DC-DC converter disclosed in Korean Patent No. 10-1464478 has a problem that a size of a core is increased due to connection of a plurality of resonance circuits to a single transformer and a size of a heat dissipation unit is also increased in proportion to the size of the core.

### SUMMARY

The inventive concept directs to provide a DC-DC converter including a plurality of transformers but capable of eliminating voltage and current imbalance between levels of input stages.

According to an aspect of the inventive concept, there is provided a DC-DC converter includes a first transformation unit including a first primary winding and a second primary winding and configured to convert a voltage applied to the first primary winding or the second primary winding and output the converted voltage to a first secondary winding; a second transformation unit including a third primary winding and a fourth primary winding and configured to convert a voltage applied to the third primary winding or the fourth primary winding and output the converted voltage to a second secondary winding; a first switch unit configured to receive a first DC input voltage and switched such that a direction of a current flowing in the first primary winding and the third primary winding changes; and a second switch unit configured to receive a second DC input voltage and switched such that a direction of a current flowing in the second primary winding and the fourth primary winding changes, wherein the first primary winding and the third primary winding are connected to each other in series, and the second primary winding and the fourth primary winding are connected to each other in series.

According to an exemplary embodiment, the DC-DC converter may further include a power switch unit switched such that a first power source unit and a second power source unit are connected to each other in parallel or in series, wherein the first power source unit applies the first DC input voltage to the first switch unit, and the second power source unit applies the second DC input voltage to the first switch unit.

According to an exemplary embodiment, a level of the first DC input voltage and a level of the second DC input voltage may be the same.

According to an exemplary embodiment, the number of turns of the first primary winding and the number of turns of the third primary winding may be the same.

According to an exemplary embodiment, the number of turns of the second primary winding and the number of turns of the fourth primary winding may be the same.

According to an exemplary embodiment, the number of turns of the first primary winding, the number of turns of the second primary winding, the number of turns of the third primary winding, and the number of turns of the fourth primary winding may be the same.

According to an exemplary embodiment, the first secondary winding may include a first winding and a second winding connected to each other in series and a first center tap formed between the first and second windings is connected to a load.

According to an exemplary embodiment, the number of turns of the first winding and the number of turns of the second winding may be the same.

According to an exemplary embodiment, the second secondary winding may include a third winding and a fourth winding connected to each other in series and a second center tap formed between the third and fourth windings is connected to a load.

According to an exemplary embodiment, the number of turns of the third winding and the number of turns of the fourth winding may be the same.

According to an exemplary embodiment, a fifth winding and a sixth winding may be formed in the first secondary winding, a seventh winding and an eighth winding may be formed in the second secondary winding, wherein the fifth winding and the seventh winding may be connected to each other in series, and the sixth winding and the eighth winding may be connected to each other in series.

According to an exemplary embodiment, a voltage output from the fifth and seventh windings may be applied to a first load.

According to an exemplary embodiment, a voltage output from the sixth and eighth windings may be applied to a second load.

According to the inventive concept, a DC-DC converter includes a plurality of transformers but may eliminate voltage and current imbalance between levels of input stages.

### BRIEF DESCRIPTION OF THE FIGURES

Example embodiments of the inventive concept will be more clearly understood from the following detailed description taken in conjunction with the accompanying drawings in which:

FIG. 1 is a block diagram of a high-capacity rectifier according to an example embodiment of the inventive concept.

FIG. 2 is a circuit diagram of a DC-DC converter according to an example embodiment of the inventive concept.

FIGS. 3 to 6 are exemplary views for explaining operations of a DC-DC converter according to an example embodiment of the inventive concept.

FIG. 7 is a circuit diagram of a DC-DC converter according to another example embodiment of the inventive concept.

FIGS. 8 to 11 are exemplary views for explaining operations of a DC-DC converter according to another example embodiment of the inventive concept.

### DETAILED DESCRIPTION OF EXEMPLARY EMBODIMENTS

Since the inventive concept may have diverse modified embodiments, preferred embodiments are illustrated in the drawings and are described in the detailed description. However, this does not limit the inventive concept within specific embodiments and it should be understood that the present invention covers all the modifications, equivalents, and replacements within the idea and technical scope of the inventive concept.

In the description of the inventive concept, certain detailed explanations of the related art are omitted when it is deemed that they may unnecessarily obscure the essence of the inventive concept. In addition, numeral figures (for example, 1, 2, and the like) used during describing the specification are just identification symbols for distinguishing one element from another element.

Further, in the specification, if it is described that one component is “connected” or “accesses” the other component, it is understood that the one component may be directly connected to or may directly access the other component but unless explicitly described to the contrary, another component may be “connected” or “access” between the components.

In addition, terms such as “ . . . unit”, “ . . . module”, or the like refer to units that perform at least one function or operation, and the units may be implemented as hardware or software or as a combination of hardware and software.

Moreover, it is intended to clarify that components in the specification are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

Hereinafter, example embodiments of the inventive concept will be described in detail.

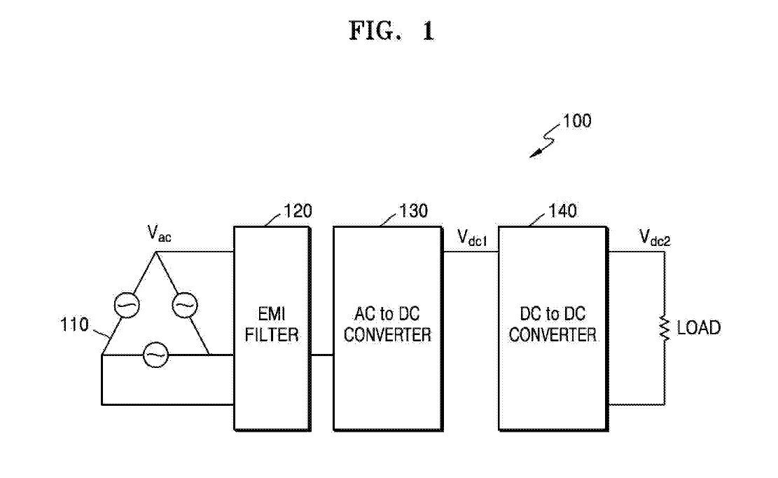

FIG. 1 is a block diagram of a high-capacity rectifier 100 according to an example embodiment of the inventive concept.

Referring to FIG. 1, the high-capacity rectifier 100 according to an example embodiment of the inventive concept may include a three-phase AC input power source 110, a noise filter (EMI filter) 120, an AC-DC converter 130, and a DC-DC converter 140.

The three-phase AC input power source 110 may provide three-phase AC power source to the noise filter 120. The noise filter 120 may remove noise of the AC power source input from the three-phase AC input power source 110 and provide the AC power source to the AC-DC converter 130. The AC-DC converter 130 may convert the AC power source from which noise has been removed to a DC voltage. For example, the DC voltage output from the AC-DC converter 130 may be 700 [V] (V_{dc1}). The DC-DC converter 140 may convert the DC voltage output from the AC-DC converter 130 into a predetermined voltage and output the converted voltage. For example, when a voltage input to the DC-DC converter 140 is 700 [V], the voltage output from the DC-DC converter 140 may be 48 [V] (V_{dc2}).

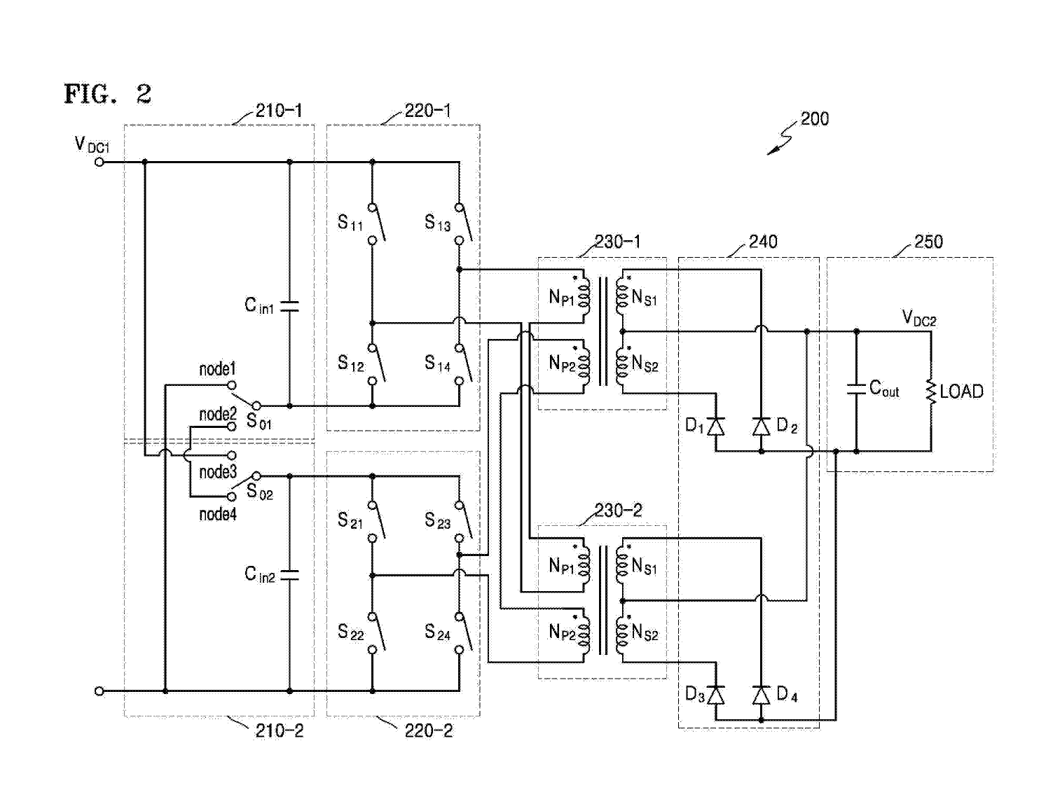

The DC-DC converter 140 may include a plurality of transformers to eliminate transformer loss or the like that can be generated in a process of converting an input voltage of Vdc1 [V] into Vdc2 [V]. Furthermore, in order to solve voltage and current imbalance between levels of input stages that can occur when using the plurality of transformers, the DC-DC converter 140 may include a winding formed in any one of the plurality of transformers and a winding formed in another transformer connected to each other in series. Components and operations of the DC-DC converter 140 according to an example embodiment of the inventive concept will be described later below in detail with reference to FIGS. 2 to 11.

FIG. 2 is a circuit diagram of a DC-DC converter 200 according to an example embodiment of the inventive concept.

Referring to FIG. 2, the DC-DC converter 200 according to an example embodiment of the inventive concept may include a first power source unit 210-1, a second power source unit 210-2, a first switch unit 220-1, a second switch unit 220-2, a second transformation unit 230-2, a rectification unit 240, and a load unit 250.

The DC-DC converter 200 according to an example embodiment of the inventive concept may convert a DC voltage input from the AC-DC converter 130 into a predetermined voltage and output the converted voltage. For example, the DC-DC converter 200 may convert a voltage of 700 [Vdc2] input from the AC-DC converter 130 into 48 [Vdc] and output the converted voltage. When a voltage input from the AC-DC converter 130 is a high voltage, the DC-DC converter 200 may divide and convert the high voltage as illustrated in FIG. 2.

Therefore, Vdc1 input from the AC-DC converter 130 may be divided into a plurality of voltages and input to corresponding switches, respectively. For example, Vdc1 may be divided into the first power source unit 210-1 and the second power source unit 210-2, and the first power source unit 210-1 may provide a first DC input voltage to the first switch unit 220-1, and the second power source unit 210-2 may provide a second DC input voltage to the second switch unit 220-2.

The first power source unit 210-1 and the second power source unit 210-2 may be connected to each other in parallel or in series according to switching operations of power switch unit. In the example of FIG. 2, the power switch unit may include a first power switch S01 and a second power switch S02. When the first power switch S01 is connected to node 1 and the second power switch S02 is connected to node 3, the first power source unit 210-1 and the second power source unit 210-2 may be connected to each other in parallel. Furthermore, when the first power switch S01 is connected to node 2 and the second power switch S02 is connected to node 4, the first power source unit 210-1 and the second power source unit 210-2 may be connected to each other in series.

Here, voltages of the first power source unit 210-1 and the second power source unit 210-2 may be set to be the same. For example, it is assumed that Vdc1 is 700 [Vdc] and the first power source unit 210-1 and the second power source unit 210-2 are connected to each other in series. Here, the first DC input voltage of the first power source unit 210-1 and the second DC input voltage of the second power source unit 210-2 may be set to correspond to 350 [Vdc]. As another example, it is assumed that Vdc1 is 700 [Vdc] and the first power source unit 210-1 and the second power source unit 210-2 are connected to each other in parallel. Here, the first DC input voltage of the first power source unit 210-1 and the second DC input voltage of the second power source unit 210-2 may be set to correspond to 700 [Vdc].

The first switch unit 220-1 receives the first DC input voltage from the first power source unit 210-1. Also, the first switch unit 220-1 may be switched such that a direction of a current flowing in the first transformation unit 230-1 and/or the second transformation unit 230-2 changes. Referring to FIG. 2, the first switch unit 220-1 may include a first switch S11, a second switch S12, a third switch S13, and a fourth switch S14. Here, the first switch S11 and the fourth switch S14 may be turned on/off together, and the second switch S12 and the third switch S13 may be turned on/off together. That is, when the first and second switches S11 and S14 are turned on, the second and third switches S12 and S13 may be turned off. Meanwhile, when the first and fourth switches S11 and S14 are turned off, the second and third switches S12 and S13 may be turned on.

The second switch unit 220-2 receives the second DC input voltage from the second power source unit 210-2. Also, the second switch unit 220-2 may be switched such that a direction of a current flowing in the first transformation unit 230-1 and/or the second transformation unit 230-2 changes. Referring to FIG. 2, the second switch unit 220-2 may include a fifth switch S21, a sixth switch S22, a seventh switch S23, and an eighth switch S24. Here, the fifth switch S21 and the eighth switch S24 may be turned on/off together, and the sixth switch S22 and the seventh switch S23 may be turned on/off together. That is, when the fifth and eighth switches S21 and S24 are turned on, the sixth and seventh switches S22 and S23 may be turned off. Meanwhile, when the fifth and eighth switches S21 and S24 are turned off, the sixth and seventh switches S22 and S23 may be turned on.

Furthermore, when the first and fourth switches S11 and S14 are turned on, the fifth and eighth switches S21 and S24 may also be turned on. On the contrary, when the first and fourth switches S11 and S14 are turned off, the fifth and eighth switches S21 and S24 may also be turned off.

A direction of a current flowing in the first and second transformation units 230-1 and 230-2 may change by operations of the first and second switch units 220-1 and 220-2. Detailed descriptions thereof will be described later below.

The first transformation 230-1 may include a first primary winding and a second primary winding. The number of turns of the first primary winding (hereinafter, referred to as “the number of the first primary winding turns”) may be Nₚ₁, and the number of turns of the second primary winding (hereinafter, referred to as “the number of the second primary winding turns”) may be Nₚ₂. The first primary winding and the second primary winding may also be formed separately in one transformer core. Also, the number of the first primary winding turns and the number of the second primary winding turns may be the same. For example, Nₚ₁ and Nₚ₂ may be the same.

Furthermore, the first transformation unit 230-1 may convert a voltage connected to the first primary winding or the second primary winding and output the voltage to a first secondary winding. In the example of FIG. 2, the first secondary winding includes a first winding and a second winding. Here, the number of turns of the first winding (hereinafter, referred to as “the number of the first winding turns”) may be Nₛ₁, and the number of turns of the second winding (hereinafter, referred to as “the number of the second winding turns”) may be Nₛ₂. Also, the number of the first winding turns and the number of the second winding turns may be the same. For example, Nₛ₁ and Nₛ₂ may be the same. Furthermore, the first winding and the second winding may be connected to each other in series.

The second transformation unit 230-2 may include a third primary winding and a fourth primary winding. The number of turns of the third primary winding (hereinafter, referred to as “the number of the third primary winding turns”) may be Nₚ₁, and the number of turns of the fourth primary winding (hereinafter, referred to as “the number of the fourth primary winding turns”) may be Nₚ₂. That is, the number of the first primary winding turns and the number of the third primary winding turns may be the same, and the number of the second primary winding turns and the number of the fourth primary winding turns may be the same. The third primary winding and the fourth primary winding may also be formed separately in one transformer core. Also, the number of the third primary winding turns and the number of the fourth primary winding turns may be the same.

Furthermore, the second transformation unit 230-2 may convert a voltage connected to the third primary winding or the fourth primary winding and output the voltage to a second secondary winding. In the example of FIG. 2, the second secondary winding includes a third winding and a fourth winding. Here, the number of turns of the third winding (hereinafter, referred to as “the number of the third winding turns”) may be Nₛ₁, and the number of turns of the fourth winding (hereinafter, referred to as “the number of the fourth winding turns”) may be Nₛ₂. Also, the number of the third winding turns and the number of the fourth winding turns may be the same. Furthermore, the third winding and the fourth winding may be connected to each other in series.

The rectification unit 240 may rectify a voltage output from the first transformation unit 230-1 or the second transformation unit 230-2 and output the rectified voltage to the load unit 250. The rectification unit 240 may include a half-bridge or a full-bridge. FIG. 2 illustrates a case where the rectification unit 240 includes a half-bridge (first to fourth diodes D₁ to D₄).

The load unit 250 may receive a DC output voltage V_{dc2} output from the rectification unit 240.

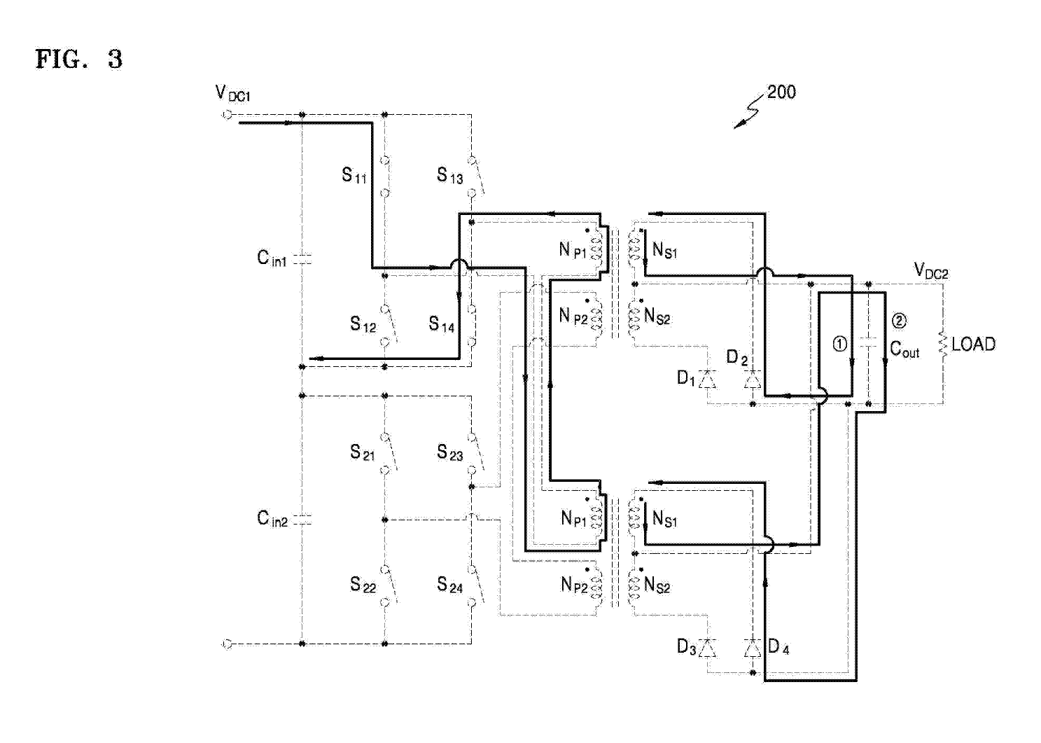

A specific operation of the DC-DC converter 200 according to an example embodiment of the inventive concept shown in FIG. 2 will be described later below in detail with reference to FIGS. 3 to 6.

FIGS. 3 to 6 are exemplary views for explaining operations of the DC-DC converter 200 according to an example embodiment of the inventive concept. It is assumed that the first power source unit 210-1 and the second power source unit 210-2 are connected to each other in series. The first and second power source units 210-1 and 210-2 may be the same as or similar to the following operations even when the first and second power source units 210-1 and 210-2 are connected to each other in parallel.

Referring to FIG. 3, only the first and fourth switches S11 and S14 of the first switch unit 220-1 are turned on and the remaining six switches are turned off. A first DC input current corresponding to the first DC input voltage of the first power source unit 210-1 may sequentially flow in the first switch S11, the third primary winding, the first primary winding, and the fourth switch S14.

A current (hereinafter, referred to as “third output current”) may be induced in the third winding because the first DC input current flows in the third primary winding. The third output current may correspond to a ratio of the number of the third primary winding turns and the number of the third winding turns. Furthermore, a current (hereinafter, referred to as “first output current”) may be induced in the first winding because the first DC input current flows in the first primary winding. The first output current may correspond to a ratio of the number of the first primary winding turns and the number of the first winding turns.

Also, as illustrated in FIG. 3, the first output current and the third output current may be combined and input to the load unit 250. Thus, even if a plurality of transformers are used, voltage and current imbalance between levels of input stages may be eliminated. Since the first output current is output through the first transformation unit 230-1 and the third output current is output through the second transformation unit 230-2 but they can be combined when they are input to the load unit 250, the same or similar effect as that generated by one transformer may occur.

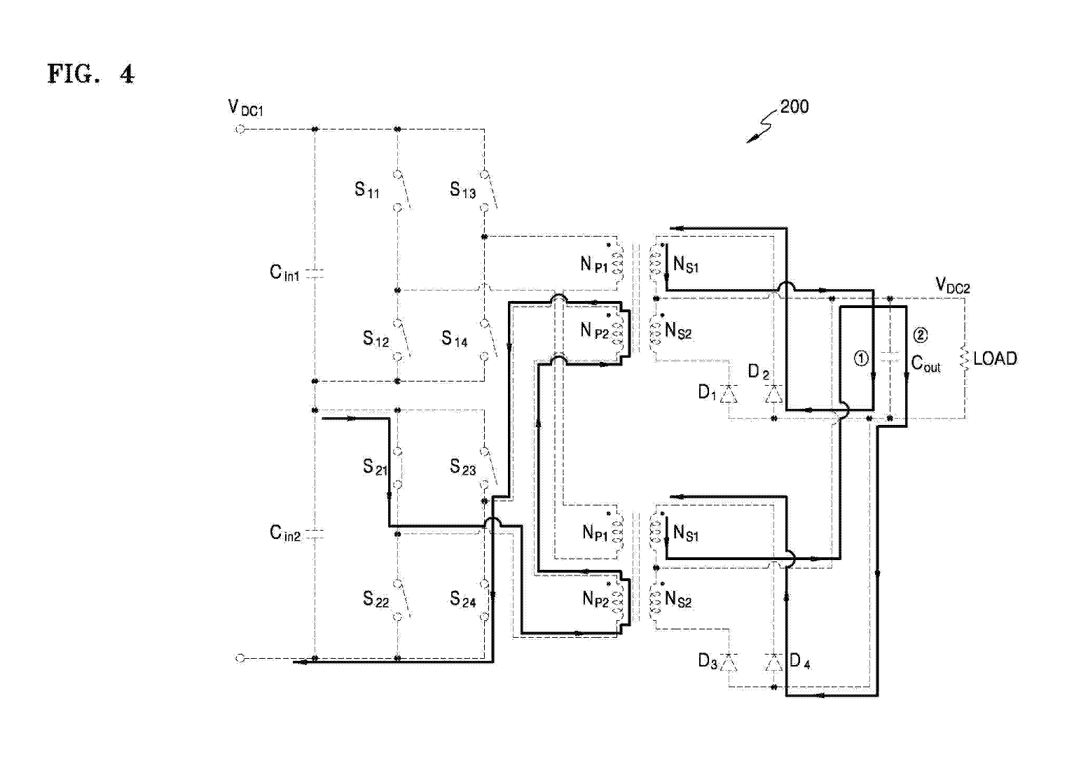

Referring to FIG. 4, only the fifth and eighth switches S21 and S24 of the second switch unit 220-2 are turned on and the remaining six switches are turned off. A second DC input current corresponding to the second DC input voltage of the second power source unit 210-2 may sequentially flow in the fifth switch S21, the fourth primary winding, the second primary winding, and the eighth switch S24.

A current (hereinafter, referred to as “third′ output current”) may be induced in the third winding because the fourth DC input current flows in the second primary winding. The third′ output current may correspond to a ratio of the number of the fourth primary winding turns and the number of the third winding turns. Furthermore, a current (hereinafter, referred to as “first′ output current”) may be induced in the first winding because the second DC input current flows in the second primary winding. The first′ output current may correspond to a ratio of the number of the second primary winding turns and the number of the first winding turns.

Also, as illustrated in FIG. 4, the first′ output current and the third′ output current may be combined and input to the load unit 250. Thus, even if a plurality of transformers are used, voltage and current imbalance between levels of input stages may be eliminated. Since the first′ output current is output through the first transformation unit 230-1 and the third′ output current is output through the second transformation unit 230-2 but they can be combined when they are input to the load unit 250, the same or similar effect as that generated by one transformer may occur.

Meanwhile, the operations illustrated in FIGS. 3 and 4 may be performed simultaneously. Because the first switch S11, the fourth switch S14, the fifth switch S21, and the eighth switch S24 may be turned on simultaneously as described above although the operations have been described separately with reference to FIGS. 3 and 4 for convenience of understanding and explanation.

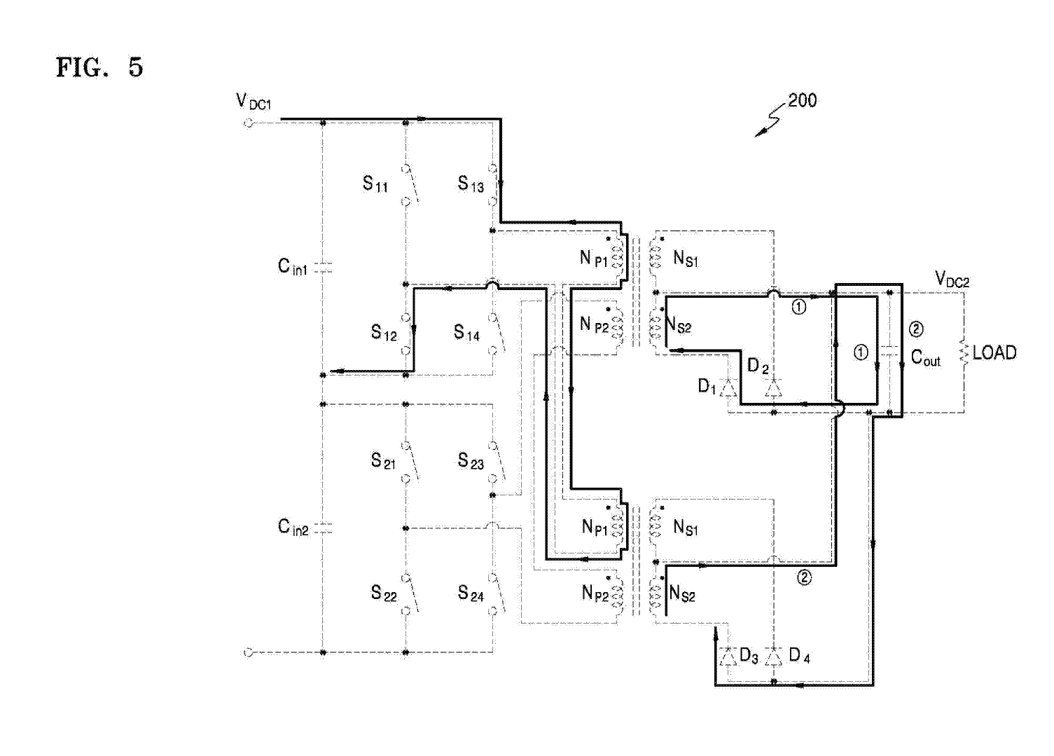

Referring to FIG. 5, only the second and third switches S12 and S13 of the first switch unit 220-1 are turned on and the remaining six switches are turned off. The first DC input current corresponding to the first DC input voltage of the first power source unit 210-1 may sequentially flow in the third switch S13, the first primary winding, the third primary winding, and the second switch S12. Here, a direction of the first DC input current flowing through the first primary winding and the third primary winding may be different from the case described with reference to FIG. 3.

A current (hereinafter, referred to as “second output current”) may be induced in the second winding because the first DC input current flows in the first primary winding. The second output current may correspond to a ratio of the number of the first primary winding turns and the number of the second winding turns. Furthermore, a current (hereinafter, referred to as “fourth output current”) may be induced in the fourth winding because the first DC input current flows in the third primary winding. The fourth output current may correspond to a ratio of the number of the third primary winding turns and the number of the fourth winding turns.

Also, as illustrated in FIG. 5, the second output current and the fourth output current may be combined and input to the load unit 250. Thus, even if a plurality of transformers are used, voltage and current imbalance between levels of input stages may be eliminated. Since the second output current is output through the first transformation unit 230-1 and the fourth output current is output through the second transformation unit 230-2 but they can be combined when they are input to the load unit 250, the same or similar effect as that generated by one transformer may occur.

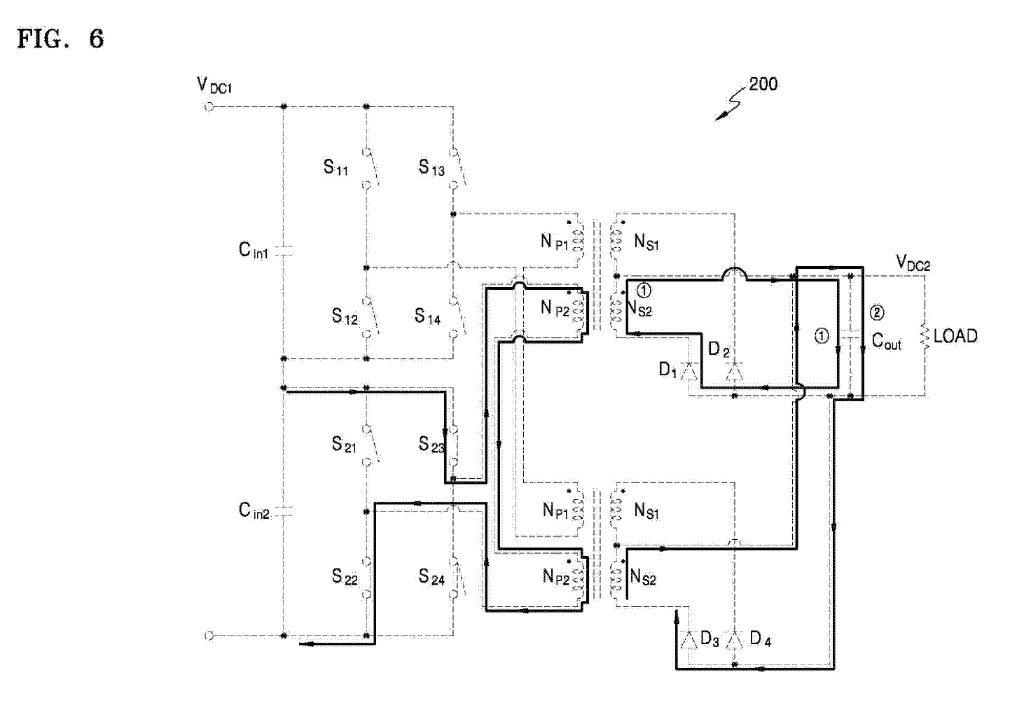

Referring to FIG. 6, only the sixth and seventh switches S22 and S23 of the second switch unit 220-2 are turned on and the remaining six switches are turned off. The second DC input current corresponding to the second DC input voltage of the second power source unit 210-2 may sequentially flow in the seventh switch S23, the second primary winding, the fourth primary winding, and the sixth switch S22. Here, a direction of the second DC input current flowing through the second primary winding and the fourth primary winding may be different from the case described with reference to FIG. 4.

A current (hereinafter, referred to as “second′ output current”) may be induced in the second winding because the second DC input current flows in the second primary winding. The second′ output current may correspond to a ratio of the number of the second primary winding turns and the number of the second winding turns. Furthermore, a current (hereinafter, referred to as “fourth′ output current”) ‘may be induced in the fourth winding because the second DC input current flows in the fourth primary winding. The fourth’ output current may correspond to a ratio of the number of the fourth primary winding turns and the number of the fourth winding turns.

Also, as illustrated in FIG. 6, the second′ output current and the fourth′ output current may be combined and input to the load unit 250. Thus, even if a plurality of transformers are used, voltage and current imbalance between levels of input stages may be eliminated. Since the second′ output current is output through the first transformation unit 230-1 and the fourth′ output current is output through the second transformation unit 230-2 but they can be combined when they are input to the load unit 250, the same or similar effect as that generated by one transformer may occur.

Meanwhile, the operations illustrated in FIGS. 5 and 6 may be performed simultaneously. Because the second switch S12, the third switch S13, the sixth switch S22, and the seventh switch S23 may be turned on simultaneously as described above although the operations have been described separately with reference to FIGS. 5 and 6 for convenience of understanding and explanation.

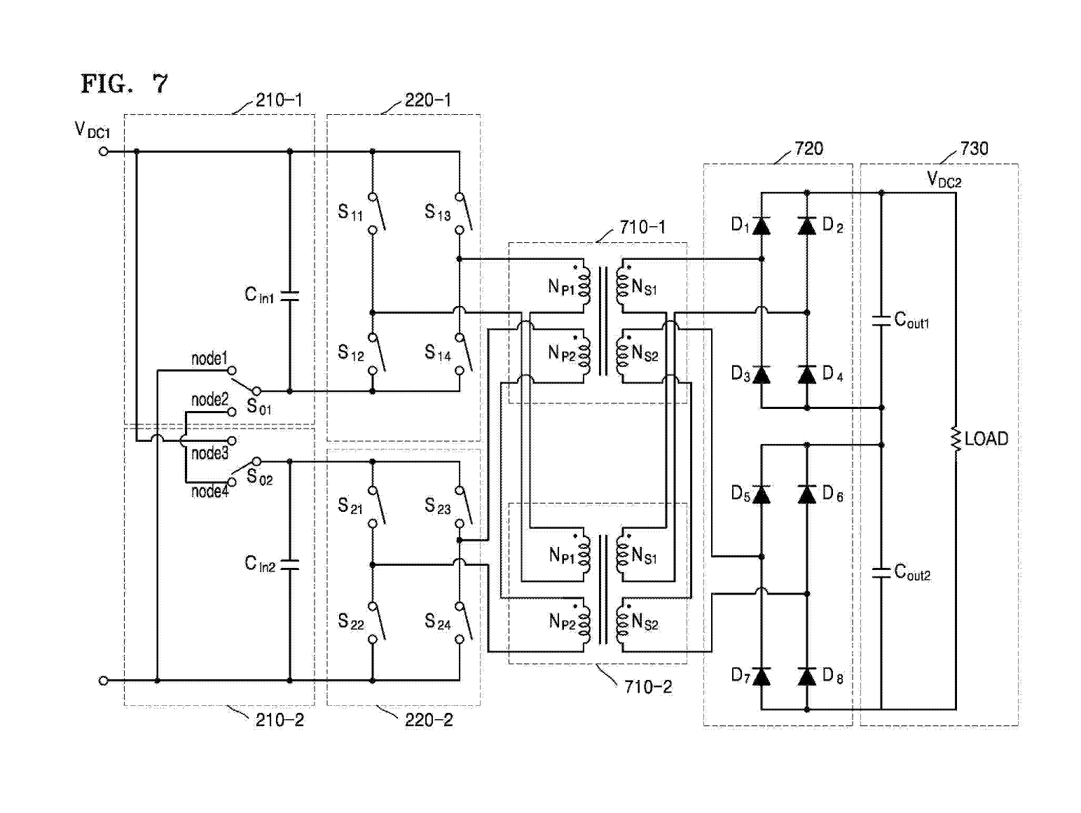

Hereinabove, the case where the voltages converted by the first and second transformation units 230-1 and 230-2 are connected to the load unit 250 in parallel has been described with reference to FIGS. 2 to 6. Hereinafter, a case where the voltages converted by the first and second transformation units 230-1 and 230-2 are connected to the load unit 250 in series will be described with reference to FIGS. 7 to 11.

FIG. 7 is a circuit diagram of a DC-DC converter 700 according to another example embodiment of the inventive concept.

Referring to FIG. 7, the DC-DC converter 700 according to another example embodiment of the inventive concept may include the first power source unit 210-1, the second power source unit 210-2, the first switch unit 220-1, the second switch unit 220-2, a first transformation unit 710-1, a second transformation unit 710-2, a rectification unit 720, and a load unit 730.

The first power source unit 210-1, the second power source unit 210-2, the first switch unit 220-1, and the second switch unit 220-2 may be the same as or similar to the configuration of the DC-DC converter 200 described with reference to FIG. 2.

Unlike the DC-DC converter 200 described with reference to FIG. 2, the DC-DC converter 700 according to another example embodiment of the inventive concept may be configured such that fifth and sixth windings formed on a secondary side of the first transformation unit 710-1 are not connected to each other in series and seventh and eighth windings formed on a secondary side of the second transformation portion 710-2 are not connected to each other in series. Meanwhile, the fifth winding formed on the secondary side of the first transformation unit 710-1 and the seventh winding formed on the secondary side of the second transformation unit 710-2 may be connected to each other in series. Meanwhile, the sixth winding formed on the secondary side of the first transformation unit 710-1 and the eighth winding formed on the secondary side of the second transformation unit 710-2 may be connected to each other in series. The number of turns of the fifth and seventh windings may be Nₛ₁ and the number of turns of the sixth and eighth windings may be Nₛ₂. Furthermore, Nₛ₁ and Nₛ₂ may be the same.

In addition, the rectification unit 720 of the DC-DC converter 700 according to another example embodiment of the inventive concept may include a full-bridge or a full-bridge. FIG. 7 illustrates a case where the rectification unit 720 includes a full-bridge (first to eighth diodes D₁ to D₈).

Furthermore, the load unit 730 of the DC-DC converter 700 according to another example embodiment of the inventive concept may include a first load Cₒᵤₜ₁ corresponding to the first DC input voltage and a second load Cₒᵤₜ₂ corresponding to the second DC input voltage. That is, an output voltage formed by converting the first DC input voltage may be applied to the first load Cₒᵤₜ₁, and an output voltage formed by converting the second DC input voltage may be applied to the second load Cₒᵤₜ₂.

Hereinafter, operations of the DC-DC converter 700 according to another example embodiment of the inventive concept will be described with reference to a part different from the DC-DC converter 200 of FIG. 2.

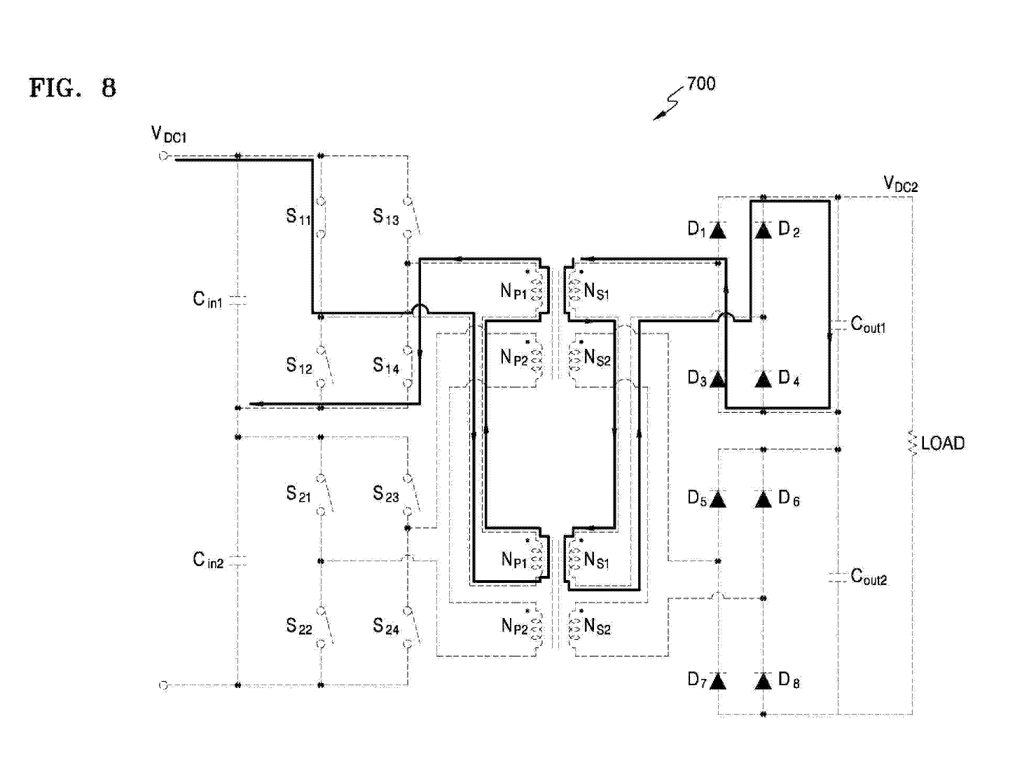

FIGS. 8 to 11 are exemplary views for explaining operations of the DC-DC converter 700 according to another example embodiment of the inventive concept. It is assumed that the first power source unit 210-1 and the second power source unit 210-2 are connected to each other in series. The first and second power source units 210-1 and 210-2 may be the same as or similar to the following operations even when the first and second power source units 210-1 and 210-2 are connected to each other in parallel.

Referring to FIG. 8, only the first and fourth switches S₁₁ and S₁₄ of the first switch unit 220-1 are turned on and the remaining six switches are turned off. The first DC input current corresponding to the first DC input voltage of the first power source unit 210-1 may sequentially flow in the first switch S₁₁, the third primary winding, the first primary winding, and the fourth switch S₁₄.

A current (hereinafter, referred to as “seventh output current”) may be induced in the seventh winding because the first DC input current flows in the third primary winding. The seventh output current may correspond to a ratio of the number of the third primary winding turns and the number of the seventh winding turns. Furthermore, a current (hereinafter, referred to as “fifth output current”) may be induced in the fifth winding because the first DC input current flows in the first primary winding. The seventh output current may correspond to a ratio of the number of the first primary winding turns and the number of the fifth winding turns.

Also, as illustrated in FIG. 8, the fifth output current and the seventh output current may be combined and input to the first load Cₒᵤₜ₁ in the load unit 730. Thus, even if a plurality of transformers are used, voltage and current imbalance between levels of input stages may be eliminated. Since the fifth output current is output through the first transformation unit 710-1 and the seventh output current is output through the second transformation unit 710-2 but they can be combined when they are input to the first load Cₒᵤₜ₁, the same or similar effect as that generated by one transformer may occur.

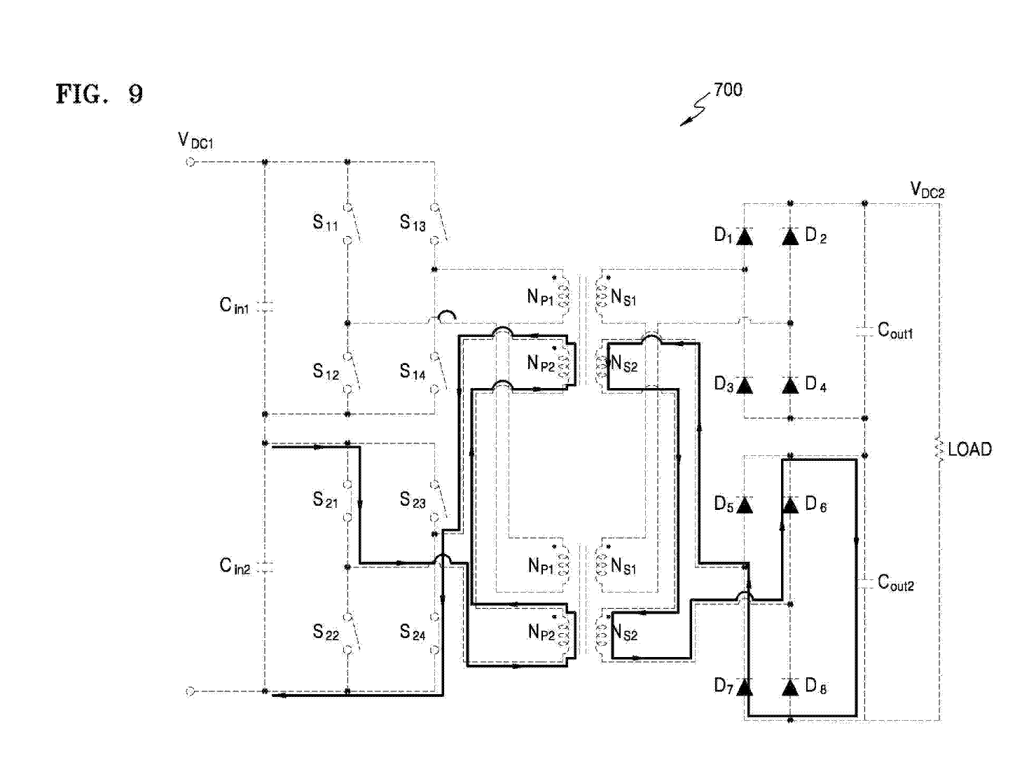

Referring to FIG. 9, only the fifth and eighth switches S₂₁ and S₂₄ of the second switch unit 220-2 are turned on and the remaining six switches are turned off. The second DC input current corresponding to the second DC input voltage of the second power source unit 210-2 may sequentially flow in the fifth switch S₂₁, the fourth primary winding, the second primary winding, and the eighth switch S₂₄.

A current (hereinafter, referred to as “eighth output current”) may be induced in the eighth winding because the second DC input current flows in the fourth primary winding. The eighth output current may correspond to a ratio of the number of the fourth primary winding turns and the number of the eighth winding turns. Furthermore, a current (hereinafter, referred to as “sixth output current”) may be induced in the sixth winding because the second DC input current flows in the second primary winding. The sixth output current may correspond to a ratio of the number of the second primary winding turns and the number of the sixth winding turns.

Also, as illustrated in FIG. 9, the sixth output current and the eighth output current may be combined and input to the second load Cₒᵤₜ₂. Thus, even if a plurality of transformers are used, voltage and current imbalance between levels of input stages may be eliminated. Since the sixth output current is output through the first transformation unit 230-1 and the eighth output current is output through the second transformation unit 230-2 but they can be combined when they are input to the second load Cₒᵤₜ₂, the same or similar effect as that generated by one transformer may occur.

Meanwhile, the operations illustrated in FIGS. 8 and 9 may be performed simultaneously. Because the first switch S₁₁, the fourth switch S₁₄, the fifth switch S₂₁, and the eighth switch S₂₄ may be turned on simultaneously as described above although the operations have been described separately with reference to FIGS. 8 and 9 for convenience of understanding and explanation. Accordingly, the first output voltage (i.e., the voltage applied to the first load Cₒᵤₜ₁) and the second output voltage (i.e., the voltage applied to the second load Cₒᵤₜ₂) that are simultaneously converted may be connected to each other in series and applied to the load unit 730.

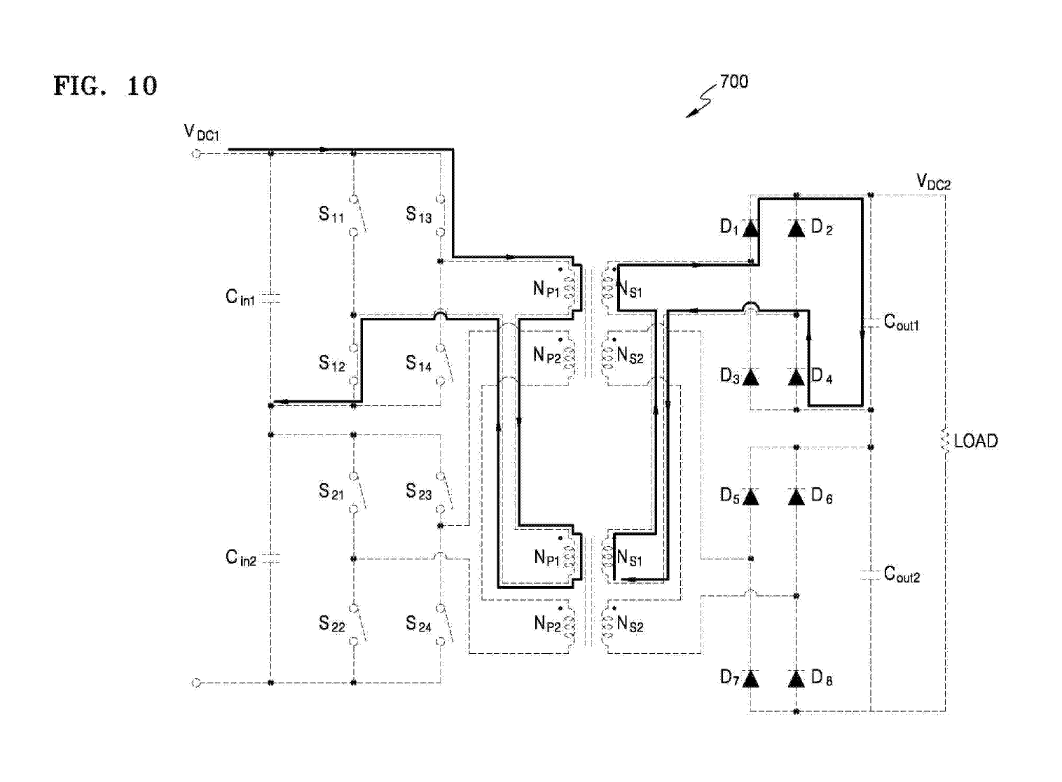

Referring to FIG. 10, only the second and third switches S₁₂ and S₁₃ of the first switch unit 220-1 are turned on and the remaining six switches are turned off. The first DC input current corresponding to the first DC input voltage of the first power source unit 210-1 may sequentially flow in the third switch S₁₃, the first primary winding, the third primary winding, and the second switch S₁₂. Here, a direction of the first DC input current flowing through the first primary winding and the third primary winding may be different from the case described with reference to FIG. 3.

A current (hereinafter, referred to as “fifth′ output current”) may be induced in the fifth winding because the first DC input current flows in the first primary winding. The fifth′ output current may correspond to a ratio of the number of the first primary winding turns and the number of the fifth winding turns. Furthermore, a current (hereinafter, referred to as “seventh′ output current”) may be induced in the seventh winding because the first DC input current flows in the third primary winding. The seventh′ output current may correspond to a ratio of the number of the third primary winding turns and the number of the seventh winding turns.

Also, as illustrated in FIG. 10, the fifth′ output current and the seventh′ output current may be combined and input to the first load Cout1. Thus, even if a plurality of transformers are used, voltage and current imbalance between levels of input stages may be eliminated. Since the fifth′ output current is output through the first transformation unit 710-1 and the seventh′ output current is output through the second transformation unit 710-2 but they can be combined when they are input to the first load Cout1, the same or similar effect as that generated by one transformer may occur.

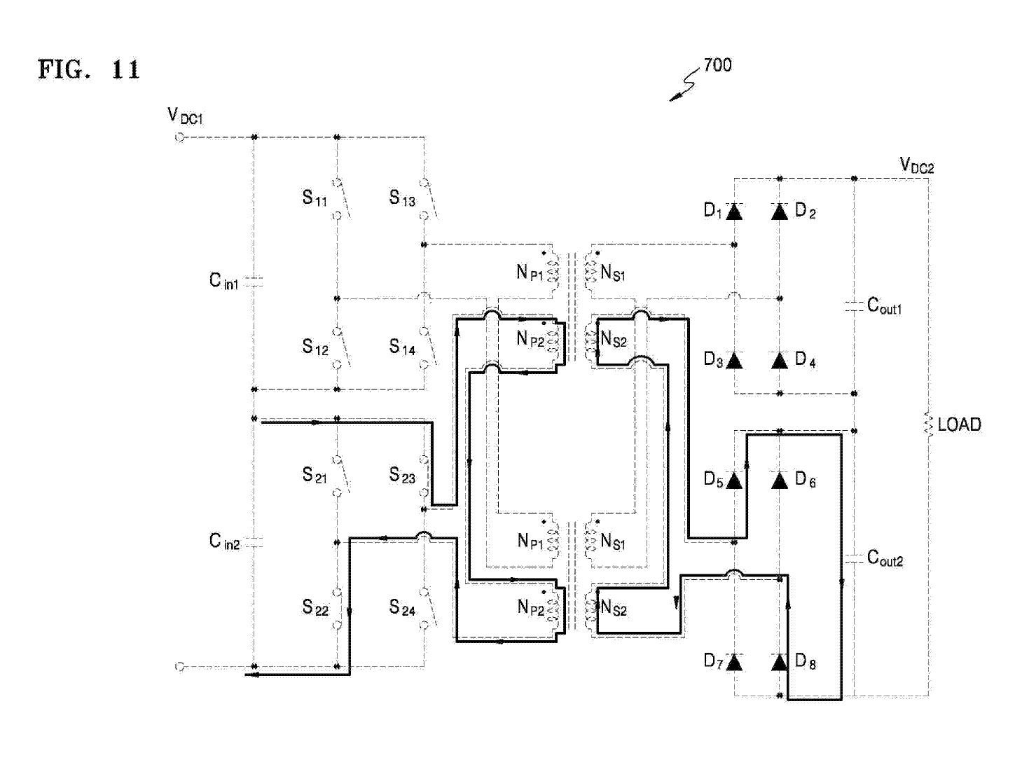

Referring to FIG. 11, only the sixth and seventh switches S22 and S23 of the second switch unit 220-2 are turned on and the remaining six switches are turned off. The second DC input current corresponding to the second DC input voltage of the second power source unit 210-2 may sequentially flow in the seventh switch S23, the second primary winding, the fourth primary winding, and the sixth switch S22. Here, a direction of the second DC input current flowing through the second primary winding and the fourth primary winding may be different from the case described with reference to FIG. 4.

A current (hereinafter, referred to as “sixth′ output current”) may be induced in the sixth winding because the second DC input current flows in the second primary winding. The sixth′ output current may correspond to a ratio of the number of the second primary winding turns and the number of the sixth winding turns. Furthermore, a current (hereinafter, referred to as “eighth′ output current”) may be induced in the eighth winding because the second DC input current flows in the fourth primary winding. The eighth′ output current may correspond to a ratio of the number of the fourth primary winding turns and the number of the eighth winding turns.

Also, as illustrated in FIG. 11, the sixth′ output current and the eighth′ output current may be combined and input to the second load Cout2. Thus, even if a plurality of transformers are used, voltage and current imbalance between levels of input stages may be eliminated. Since the sixth′ output current is output through the first transformation unit 710-1 and the eighth′ output current is output through the second transformation unit 710-2 but they can be combined when they are input to the second load Cout2, the same or similar effect as that generated by one transformer may occur.

Meanwhile, the operations illustrated in FIGS. 10 and 11 may be performed simultaneously. Because the second switch S12, the third switch S13, the sixth switch S22, and the seventh switch S23 may be turned on simultaneously as described above although the operations have been described separately with reference to FIGS. 10 and 11 for convenience of understanding and explanation. Accordingly, the first output voltage and the second output voltage that are simultaneously converted may be connected to each other in series and applied to the load unit 730.

While the inventive concept has been particularly shown and described with reference to embodiments thereof, it will be understood that various changes in form and details may be made therein without departing from the scope of the inventive concept.

What is claimed is:

1. A DC-DC converter comprising:
a first transformation unit including a first primary winding and a second primary winding and configured to convert a voltage applied to the first primary winding or the second primary winding and output the converted voltage to a first secondary winding;
a second transformation unit including a third primary winding and a fourth primary winding and configured to convert a voltage applied to the third primary winding or the fourth primary winding and output the converted voltage to a second secondary winding;
a first switch unit configured to receive a first DC input voltage and switched such that a direction of a current flowing in the first primary winding and the third primary winding changes; and
a second switch unit configured to receive a second DC input voltage and switched such that a direction of a current flowing in the second primary winding and the fourth primary winding changes,
wherein the first primary winding and the third primary winding are connected to each other in series, and the second primary winding and the fourth primary winding are connected to each other in series.

2. The DC-DC converter of claim 1, further comprising:
a power switch unit switched such that a first power source unit and a second power source unit are connected to each other in parallel or in series, wherein
the first power source unit applies the first DC input voltage to the first switch unit, and the second power source unit applies the second DC input voltage to the first switch unit.

3. The DC-DC converter of claim 1, wherein
a level of the first DC input voltage and a level of the second DC input voltage are the same.

4. The DC-DC converter of claim 1, wherein
the number of turns of the first primary winding and the number of turns of the third primary winding are the same.

5. The DC-DC converter of claim 1, wherein
the number of turns of the second primary winding and the number of turns of the fourth primary winding are the same.

6. The DC-DC converter of claim 1, wherein
the number of turns of the first primary winding, the number of turns of the second primary winding, the number of turns of the third primary winding, and the number of turns of the fourth primary winding are the same.

7. The DC-DC converter of claim 1, wherein
the first secondary winding includes a first winding and a second winding connected to each other in series and a first center tap formed between the first and second windings is connected to a load.

8. The DC-DC converter of claim 7, wherein
the number of turns of the first winding and the number of turns of the second winding are the same.

9. The DC-DC converter of claim 1, wherein
the second secondary winding includes a third winding and a fourth winding connected to each other in series and a second center tap formed between the third and fourth windings is connected to a load.

10. The DC-DC converter of claim 9, wherein
the number of turns of the third winding and the number of turns of the fourth winding are the same.

11. The DC-DC converter of claim 1, wherein
a fifth winding and a sixth winding are formed in the first secondary winding, a seventh winding and an eighth winding are formed in the second secondary winding, wherein the fifth winding and the seventh winding are connected to each other in series, and the sixth winding and the eighth winding are connected to each other in series.

12. The DC-DC converter of claim 11, wherein
a voltage output from the fifth and seventh windings is applied to a first load.

13. The DC-DC converter of claim 11, wherein
a voltage output from the sixth and eighth windings is applied to a second load.
